(19) United States
(12) Patent Application Publication
(10) Pub. No.: US 2003/0204633 A1
(43) Pub. Date: Oct. 30, 2003

(54) Method and apparatus for updating operating instructions in a modem in a router

(75) Inventors: Don A. Dykes, Houston, TX (US); G. Byron Sands, Spring, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX

(21) Appl. No.: 10/135,462

(22) Filed: Apr. 30, 2002

(51) Int. Cl. G06F 15/16

(52) U.S. Cl. 709/250

(57) ABSTRACT

A router is provided. The router comprises a modem, a switch, a first set of connectors, a second connector, and a controller. The switch is movable between first and second operating positions. The first set of connectors is adapted to be coupled to a first plurality of external devices. The second connector is adapted to be coupled to a second external device, and the controller is adapted to route data between the first plurality of external devices and the modem in response to the switch being in the first operating position, and to route data between the second external device and the modem in response to the switch being in the second operating position.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates generally to routers, and, more particularly, to a method and apparatus for updating operating instructions in a modem located within the router.

2. Background of the Invention

Use of the World Wide Web or internet has become relatively widespread, with many people gaining access to the internet through a variety of conventional devices. For example, many individuals with desktop personal computers (PCs) use both internal and external modems (modulator-demodulators) to interface their PCs with a conventional telephone subscriber line. Typically, the desktop PC communicates with the modem through one or more of their standard interfaces, such as a product component interface (PCI) bus or an industry standard architecture (ISA) bus. Portable computers, such as laptop or notebook computers, likewise use modems to gain access to the internet. However, owing to the configuration of these portable computers, they often employ a modem that has been configured on a removable card that communicates with the PC through a personal computer memory card international association (PCMCIA) bus. Operation of these modems is typically effected by a micro-controller operating under software control. Often, the software is comprised of a set of operating instructions that are stored in a nonvolatile or flash memory on-board the modem. Thus, the operation of the modem may be altered by rewriting the operating instructions stored in the nonvolatile memory. The ability to rewrite the operating instructions stored in the modem may be advantageous to correct newly discovered defects or “bugs,” to add additional functions to the modem, to accommodate new standards, etc. The process of rewriting the operating instructions stored in the flash memory has become known as “flashing” the modem. Typically, an executable program, which contains or has access to a new set of operating instructions, is distributed to the PCs, such as via the Internet, floppy diskette, compact disc, or the like. When the PC executes the program, the new set of operating instructions are loaded into the flash memory of the modem coupled to the PC, such as through the PCI, ISA, or PCMCIA bus.

This system of providing an individual modem for each individual user has worked well for providing individual users with access to the internet. However, for networks comprised of groups of PCs or clients, providing a separate modem for each client is redundant and unnecessarily expensive. Moreover, individual, unregulated access to the internet raises significant security issues for a network.

Accordingly, routers have been used to provide a controlled, single-point-of-access to the internet for networks. Often, the router employs one or more modems that provide the interface between the individual network clients and the internet. The router also controls the flow of information between each of the clients and the internet so that the proper information is routed to the proper client. Often, to make the routers affordable, they are constructed from existing, standardized components. For example, the routers may include one or more conventional modems, such as those used in PCs, laptops, or notebooks.

Routers, however, do not normally include the hardware needed to flash the modems. Thus, in some devices, a method typically used to upgrade the operating instructions in a modem contained in the router involves removing the modem, installing the modem in appropriately configured PC, laptop, or notebook, flashing the peripatetic modem, and then returning it to the router. Such a system is inconvenient to implement, time consuming, and prone to failure, and/or damage to the modem.

The present invention is directed to overcoming, or at least reducing the effects of, one or more of the problems set forth above.

### BRIEF SUMMARY OF THE INVENTION

In one aspect of the present invention, a method for flashing a modem contained within a router is provided. The method comprises providing an indication that the router is in one of a normal and programming mode of operation. Data received over a first primary connector is delivered to one of a second primary connector and the modem in response to the router being in a normal mode of operation. Data received over a secondary connector is delivered to the modem in response to the router being in a programming mode of operation.

In another aspect of the present invention, a router is provided. The router comprises a modem, a switch, a first set of connectors, a second connector, and a controller. The switch is movable between first and second operating positions. The first set of connectors is adapted to be coupled to a first plurality of external devices. The second connector is adapted to be coupled to a second external device, and the controller is adapted to route data between the first plurality of external devices and the modem in response to the switch being in the first operating position, and to route data between the second external device and the modem in response to the switch being in the second operating position.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates one embodiment of a computer system;

FIG. 2 schematically illustrates a high level block diagram of a modem used in the computer system of FIG. 1;

FIG. 3 schematically illustrates a block diagram of a router used and in the computer system of FIG. 1; and

FIG. 4 schematically illustrates one embodiment of a flow chart of a control 20 methodology that may be implemented in the router of FIGS. 1 and 3.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

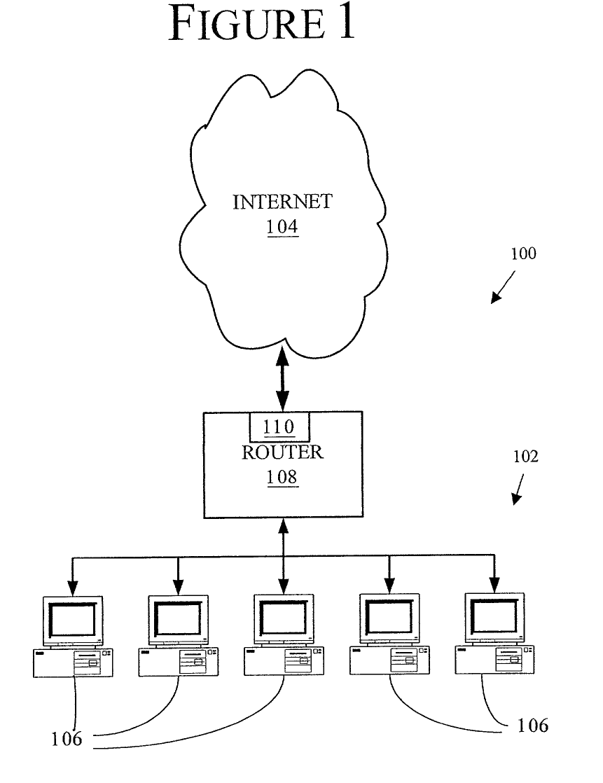

Turning first to FIG. 1, a general block diagram of a computer system 100 is shown. The computer system 100 includes a network 102 coupled to an intranet or internet 104. The network 102 is comprised of a plurality of PCs or clients 106, coupled to a router 108. The router 108 includes a modem 110, which acts as an interface between the internet 104 and each of the clients 106.

Generally, the router 108 provides a plurality of conventional functions, such as allowing communications among the clients 106, as well as allowing communication between the Internet 104 and each of the clients 106. Generally, requests for cites or pages on the Internet 104 are transmitted from one or more of the clients 106 through the router 108 and modem 110 to the Internet 104. The appropriate cite within the Internet 104 responds with information that is delivered through the modem 110 and router 108 back to the requesting client 106. The router 108 generally coordinates the transfer of information between the Internet and each of the clients 106, insuring that the requesting client 106 receives the requested information or data from the Internet 104 when it is returned. The operation of the router 108 in providing these functions is conventional and not described in greater detail herein to avoid unnecessarily obscuring the instant invention.

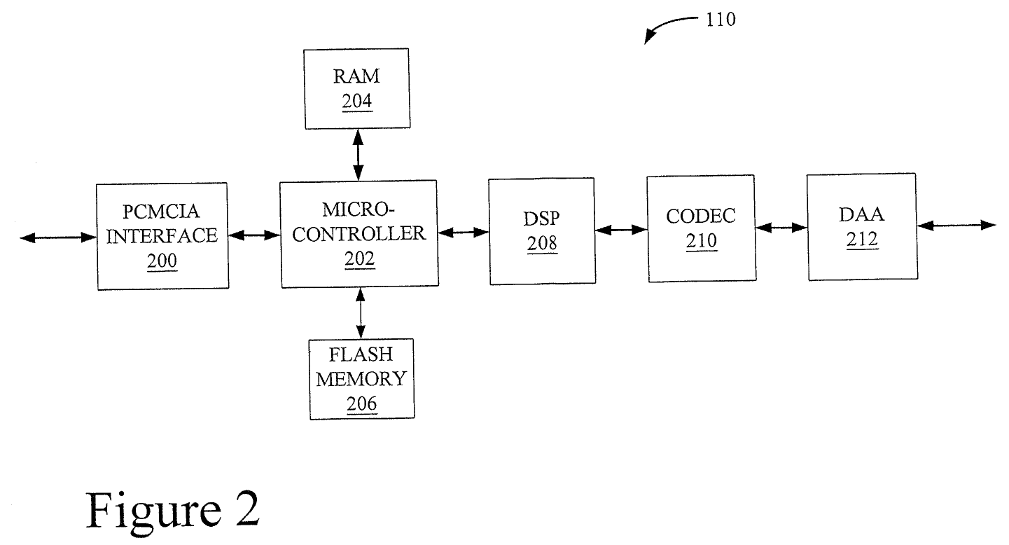

The modem 110 can take on any of a variety of conventional forms and may be interfaced with the router 108 via any of a variety of conventional interfaces, such as a PCMCIA bus modem, a PCI bus modem, an ISA bus modem, or the like. In the illustrated embodiment, the instant invention takes advantage of the relatively widespread availability of conventional, off-the-shelf modems. An exemplary high-level block diagram of a modem 110 that may be employed in the instant invention is illustrated in FIG. 2. Generally, the modem 110 is comprised of a data access arrangement (DAA) 212, which acts as an interface between the modem 110 and a conventional subscriber line, such as may be provided by a telephone company. The modem 110 also includes a coder/decoder (CODEC) 210 that operates to receive the data delivered from the subscriber line through the DAA 212 to code or decode the data from the form transmitted over to the subscriber line to a form used within the digital domain of the modem 110. A digital signal processor 208 also operates on the data to further transform it into a form useable by a microcontroller 202.

Generally, the microcontroller 202 operates under software control to effect proper sequencing within the modem 110. The microcontroller 202 generally has two types of memory available to it, such as a volatile memory, including random access memory 204, and a nonvolatile memory, such as a flash memory 206. The flash memory 206 stores software instructions that form a relatively low level or simple operating system that instructs the microcontroller 202 to carry out its proper operation. The rain 204, on the other hand, is generally used as a “scratchpad” or temporary storage area used by the microcontroller 202 during its operation.

A PCMCIA bus interface 200 forwards information between the modem 110 and the router 108. In the embodiment illustrated in FIG. 2, the modem 110 is, of course, a PCMCIA bus type modem that is selected because of its relatively easy ability to be inserted or placed in the router 108 and/or removed therefrom. However, those skilled in the art will appreciate that any of a variety of conventional modems may be used in place of the PCMCIA bus modem 110 illustrated in FIG. 2 without departing from the spirit and scope of the instant invention.

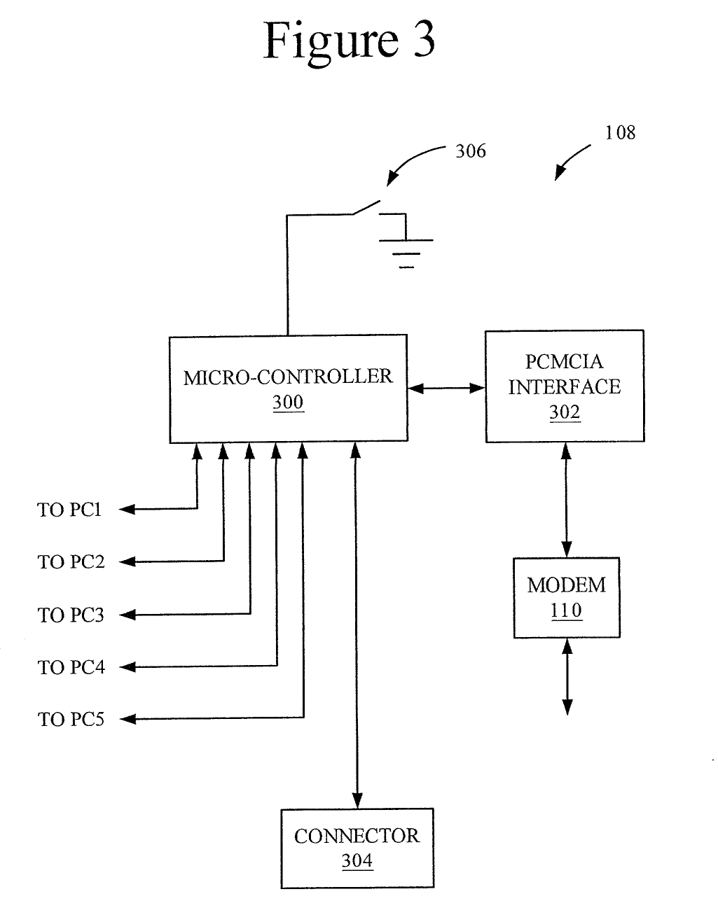

Turning now to FIG. 3, a top level block diagram of at least a portion of the router 108 is illustrated in block diagram form. The router 108 includes a microcontroller 300 that is coupled through a PCMCIA interface 302 to the modem 110, and in particular to the PCMCIA interface 200 contained within the modem 110. The microcontroller 300 is also coupled to each of the clients 106, which for ease of illustration has been shown in FIG. 3 by labels is PC1 PC5. The primary function of the router is to pass communications between the clients 106 PC1-PC5 and to pass communications between each of the clients 106 PC1-PC5 and the modem 110, thus the connections between the router 108 and the clients 106 are generally referred to as the primary connections.

A conventional connector 304, such as an RS232 type connector, is located on an external face of the router 108 and provides a connection point between the microcontroller 300 and devices external to the router 108. The RS232 interface is selected because it is a relatively standard connection provided on many, if not all, commercially available PCs. The connector 304 is intended to be coupled through a cable (not shown) to a PC, which may be one of the PCs 106 included within the network 102. The connector 304 is not generally responsible for passing communications between the PCs 106, but rather, is limited to passing communications between the external device and the modem 110, and thus, is referred to as the secondary connector. In one embodiment, the connector 304 is coupled via the cable (not shown) to a similar connector (not shown) on one of the clients 106, such as the serial input/output connector normally located on a rear surface of the PC 106.

The microcontroller 300 is also coupled to a switch 306. The switch 306 may take on the form of an externally accessible, manually actuated switch. The switch 306 may be manually manipulated between closed and open positions, which will provide logic signals to the microcontroller 300 indicative of the status of the switch 306. For example, in the illustrated embodiment, when the switch is moved to the open position, a pull-up resistor 308 causes a high logic signal to be delivered to the microcontroller 300. On the other hand, when the switch 306 is closed, a low logic signal is delivered to the microcontroller 300.

Manipulation of the switch 306 allows a user to alter the operation of the microcontroller 300 between a normal mode of operation and a programming mode of operation. In the normal mode of operation, the microcontroller 300 operates in a conventional manner to control communications between the external PCs 106 and the modem 110 through the PCMCIA interface 302. That is data communicated by one of the external PCs 106 is received by the microcontroller 300, its intended recipient is determined from information contained in the data, and then the microcontroller routes the data to the intended recipient, which may be one of the other external PCs 106 or the modem 110.

When the microcontroller 300 moves to the programming mode of operation, which is initiated by manipulating the switch 306, a software control routine is executed that allows a device coupled to the connector 304 to communicate with the modem 110 through the PCMCIA interface 302. This communication path through the connector 304 may be used by the external device to program or flash the modem 110. Thus, the external device coupled to the connector 304 may run and executable program, which may be distributed by the manufacturer of the modem 110, that reprograms, updates, or otherwise flashes new data into the modem 110. This new data is delivered out of the external device and through the connector 304 to the microcontroller 300. Because the microcontroller 300 is in the programming mode of operation, it “knows” to pass the new data to the modem 110 through the PCMCIA interface 302. Thus, the modem 110 may be updated with this new data without the need for it to be removed from the router 108, installed in a conventional PC, and updated by running the executable program in the conventional PC.

Generally, the PCMCIA interface 302 operates to convert the format of data received from the microcontroller 300 to a form generally accepted by PCMCIA type devices. The PCMCIA interface 200 within the modem 110 operates to convert the format of the data received from the microcontroller 300 and PCMCIA interface 302 to a format acceptable to and used by the internal circuitry contained within the modem 110. Moreover, data traveling in the opposite direction, from the modem 110 to the controller 300, will likewise be converted between PCMCIA formats and Non-PCMCIA formats as needed. That is, the PCMCIA interfaces 200, 302 insure that the microcontroller 300 and modem 110 are able to communicate with one another using the standardized PCMCIA protocol.

To prevent misoperation of the modem 110 during the programming mode of operation, the microcontroller 300 effectively blocks the delivery data from the PCs 106 to the modem 110. That is, the operation of the modem 110 during updating or flashing may be impaired if other data or control signals are received from the PCs 106. Thus, the microcontroller 300 blocks or otherwise prevents signals delivered from the PCs 106 from being delivered to the modem 110 during the programming mode of operation.

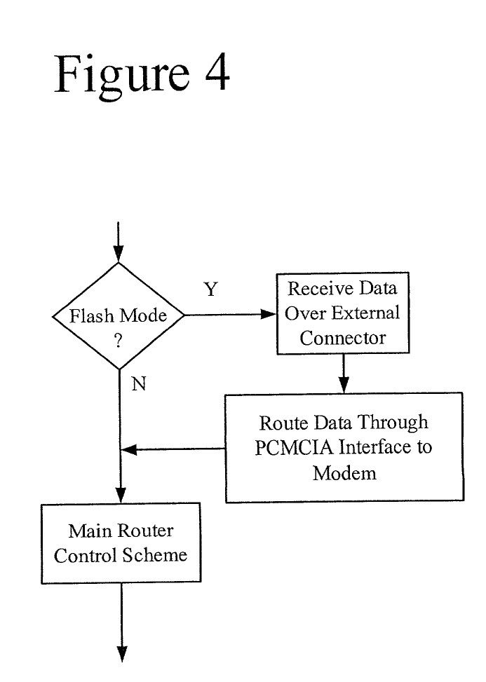

One exemplary embodiment of the software control routine 400 executed by the microcontroller 300 is shown in flowchart form in FIG. 4. The control routine 400 enters into a decision block 402 where the control routine 400 determines if the router 108 is in the programming or flash mode. That is, the control routine 400 examines the status of the switch 306 to determine if a user has manually manipulated the switch 306 to the programming mode. If the router 108 is in the normal mode of operation, the control routine 400 passes to control block 404 where the main or normal control scheme is executed.

Alternatively, if the router 108 is in the flash mode, the control routine 400 passes to control block 406 where the microcontroller 300 monitors the connector 304 to receive data from an external device. In block 408, the control routine passes data received from the connector 304 through the PCMCIA interface 302 to the modem 110. In this manner, the external device may communicate with the modem 110 in a manner similar to that as if the modem 110 were installed in the external device. Thus, the external device is capable of providing data or programming code that the microcontroller 202 in the modem 110 may appropriately store in the RAM 204 or flash memory 206.

The control routine 300 will continue passing data from the connector 304 to the modem 110 as long as the router 108 remains in the programming or flash mode. At such time as a user desires to return the router 108 to the normal mode operation, the switch 306 may be manipulated, causing the control routine 300 at the decision block 402 to pass to the main or normal control scheme in block 404.

In an alternative embodiment of the instant invention, the function of the manual switch 306 may be replaced by a control signal delivered directly from the external device over the connector 304, for example. That is, one line from the connector 304 may be coupled to the input terminal 310 so that the external device can deliver a signal through the connector 304 that causes the microcontroller 300 to selectively switch between the normal and programming modes of operation. In this embodiment, the process of flashing the modem 110 may be automated by removing the necessity of having a user physically approach the router 108 and manipulate the switch 306.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below. Accordingly, the protection sought herein is as set forth in the claims below.

What is claimed:

1. A method for flashing a modem contained within a router, comprising:
providing an indication that the router is in one of a normal and programming mode of operation;
delivering data received over a first primary connector to one of a second primary connector and the modem in response to the router being in a normal mode of operation; and
delivering data received over a secondary connector to the modem in response to the 10 router being in a programming mode of operation.

2. A method, as set forth in claim 1, wherein delivering data received over the secondary connector to the modem in response to the router being in the programming mode of operation further comprises delivering data received over the secondary connector to the modem via a PCMCIA interface in response to the router being in the programming mode of operation.

3. A method, as set forth in claim 1, wherein delivering data received over the first primary connector to the second primary connector and the modem in response to the router being in a normal mode of operation further comprises delivering data received over the first primary connector to the modem via a PCMCIA interface in response to the router being in the normal mode of operation.

4. A method, as set forth in claim 1, wherein delivering data received over the first primary connector to the second primary connector and the modem in response to the router being in a normal mode of operation further comprises blocking delivery of data received over the first primary connector to the modem in response to the router being in the programming mode of operation.

5. A method, as set forth in claim 1, wherein providing an indication that the router is in one of a normal and programming mode of operation, further comprises manipulating a switch between first and second operating positions to provide first and second signals.

6. A method, as set forth in claim 1, wherein delivering data received over a secondary connector to the modem in response to the router being in a programming mode of operation further comprises delivering data capable of reprogramming the modem 110.

7. An apparatus for flashing a modem contained within a router, comprising:
means for providing an indication that the router is in one of a normal and programming mode of operation;
means for delivering data received over a first primary connector to one of a second primary connector and the modem in response to the router being in a normal mode of operation; and
means for delivering data received over a secondary connector to the modem in response to the router being in a programming mode of operation.

8. A router, comprising:
a modem
a switch movable between first and second operating positions;
a first set of connectors adapted to be coupled to a first plurality of external devices; a second connector adapted to be coupled to a second external device; and
a controller adapted to route data between the first plurality of external devices and the modem in response to the switch being in the first operating position, and to route data between the second external device and the modem in response to the switch being in the second operating position.

9. A router, as set forth in claim 8, including a PCMCIA interface disposed between the controller and the modem and adapted to receive data from the controller and pass the data to the modem in a PCMCIA format.

10. A router, as set forth in claim 8, wherein the controller is further adapted to block delivery of data received over the first primary connector to the modem in response to the router being in the programming mode of operation.
